(19) United States
(12) Patent Application Publication
(10) Pub. No.: US 2003/0221628 A1
(43) Pub. Date: Dec. 4, 2003

(54) Wall supported modular cat furniture structure

(76) Inventor: Sylvia Ann Leon, Escondido, CA (US)

Correspondence Address: SYLVIA ANN LEON, 1365 OAK VIEW WAY, ESCONDIDO, CA, 92029, US

(21) Appl. No.: 10/383,489

(22) Filed: Mar. 10, 2003

Related U.S. Application Data
(60) Provisional application No. 60/365,030, filed on Mar. 18, 2002.

(51) Int. Cl. A01K 29/00; A01K 15/02

(52) U.S. Cl. 119/28.5; 119/706

(57) ABSTRACT

A wall supported modular cat furniture structure is disclosed comprising a number of interconnecting components such as vertical posts, horizontal platforms, and base coupling which are press-fitted together to form an upright structure characterized by a central support post to which platforms connect and extend outward therefrom. The structure is positioned adjacent a flat wall or a corner wall surface and platform edges are securely attached to the supporting wall giving stability to the structure, added support to the platforms, and effectively restricting the movement of both. The structure, which satisfies the needs of cats to climb, scratch, and perch in elevated places, has carpet, sisal rope or other claw penetrable material covering exposed surfaces. Numerous other advantages are claimed herein including having lightweight, interchangeable components, a variety of height and configuration options, simple construction and assembly, vertical expandability and minimal space requirements for use.

### RELATED APPLICATIONS

This invention claims the benefit of Provisional Patent Application No. 60/365,030 filed Mar. 18, 2002, entitled “Wall Supported Modular Structure”.

### FIELD OF THE INVENTION

This invention is related to wall supported modular cat furniture devices and more particularly to a cat climbing, scratching and perching home furnishing structure.

### BACKGROUND

Cat furniture can be described as a home furnishing having a purpose of satisfying the natural needs of cats, primarily the need to climb, to scratch, and to perch in high places. Without suitable options many indoor cats will resort to using other home furnishings to satisfy these needs, damaging and often ruining these items. A variety of cat furniture devices have been disclosed that adequately satisfy these needs. Although individually unique, these devices share the following characteristics: sufficient claw penetrable material to facilitate climbing; a scratching surface preferred by cats; and an elevated perching surface.

In addition to these three characteristics, the prior art has identified a number of other characteristics as main objectives and have sought to incorporate each into the various cat furniture devices. These other characteristics are desired to improve functionality, increase convenience of use, or raise the general appeal of the cat furniture device. These desirable characteristics are identified in the list below.

A cat furniture device should:

1) be attractive or aesthetically appealing, complementing the existing room décor.

2) be stable and sturdy enough to promote carefree and confident use by cats.

3) have claw receptive material on exterior surfaces which facilitates climbing.

4) require minimal space, particularly minimal floor space.

5) not be obtrusive with relation to surrounding living space.

6) comprise of multiple perches or platforms to accommodate multiple cats.

7) comprise of perches that are of sufficient strength to support multiple cats.

8) include at least one significantly elevated perch or platform.

9) be of a break down nature which facilitates transporting and storing the device.

10) be easy to assemble, disassemble, install and uninstall.

11) be suited to repeated assembly, disassembly, installation and uninstallation.

12) be sufficiently lightweight to allow hassle free handling.

13) be of a modular construction where modules are interchangeable.

14) be of a modular construction where variations in shape or configuration are possible.

15) be of a modular construction where variations in size or height are possible.

16) be adaptable to various installations.

17) be of simple construction.

18) be economical to manufacture.

An evaluation of the prior art with respect to the above list is described below. In summary, most devices had a majority of the items listed. Several, however, could claim all but a few of the characteristics as noted below.

U.S. Pat. Nos. 3,479,990, 3,479,991 and 3,595,209 disclose devices described as floor to ceiling multi-perch cat stands having a spring-loaded tension mechanism holding them in place. These attractive, space-saving, often portable devices have stability and strength limitations resulting from inadequate tension devices. The device moves considerably under normal use by two or more cats and the tension mechanism often gives way under the force of a large cat jumping on or off the device. Additionally, the size or height of the device can not be varied since this is dependent on the distance between the floor and the ceiling.

U.S. Pat. Nos. 4,497,279 and 6,431,120 B1 disclose devices that are well suited for use by multiple cats as they are tall, exceptionally sturdy and stable, and have two or more elevated perches. Although these devices can be disassembled into more manageable parts for transporting and storing, the complexity of their construction make this very difficult and time consuming. Furthermore, there are no options during reassembly as the device must take its original form, which is generally bulky, excessively heavy, and space consuming.

U.S. Pat. Nos. 5,577,465, 5,577,466, 5,806,464 and 5,884,586 disclose devices that can be described as free standing modular structures extending upward from a base or legs, having modules that can be assembled into various shapes and sizes. The problem with these devices is that as modules are added to gain height for an elevated perch, larger heavier bases are needed to stabalize the structure resulting in a bulky, heavy, space consuming device.

The device described in U.S. Pat. No. 5,829,390 achieves gaining height and stability with minimal floor space requirements. Here a perching unit installs above and attaches to the top of a doorframe. A climbing post extends from the perch to the floor, along side the doorway, which has stair-like steps that spiral down the length of it. Although functional, the construction of this device is very complex, making it difficult to assemble and install, and costly to reproduce. Additionally, installation is limited to doorways and there are no options for changing the shape or the size of the device.

The device in U.S. Pat. No. 5,875,735 similarly uses wall support to gain height and stability without consuming large amounts of floor space. This device can be installed on any wall surface, or in any corner, and the modular design allows for a variety of configurations and heights. The problem with this device is that the construction is very complex making it difficult to assemble and install and costly to manufacture.

This evaluation found the prior art to be without a device that offers all of the advantages represented in the list of desirable cat furniture device characteristics contained herein. Accordingly, there is a need to provide a cat furniture device that can claim the benefit of all the desired characteristics listed herein. Furthermore, and of equal importance, there is a need to contribute to and expand this list through novel or adapted design objectives.

The principle object of this invention is to provide a cat furniture structure that has incorporated into its design all of the aforementioned list of desirable characteristics of cat furniture devices. Additionally, it is another objective of this invention to provide a modular structure having components that are reversible as well as interchangeable. This would allow worn components to be turned over or turned around effectively extending the life of the components. Furthermore, given that cats are exceptionally agile climbers even at considerable heights, it is another objective of this invention to provide a device that has unlimited upward range. Vaulted ceilings and second level lofts are two common applications where a structure with unlimited upward range would be advantageous. Further objectives and advantages of the invention will become apparent from consideration of the illustrations and ensuing descriptions.

### BRIEF SUMMARY OF THE INVENTION

An attractive and easy to assemble wall supported modular cat furniture structure is disclosed. The structure comprises a plurality of interconnecting components, such as vertical posts, horizontal platforms, and base couplings, which are press fitted together to form an upright vertical structure characterized by a central support post to which the platforms connect and extend outward therefrom. The structure is positioned adjacent a flat wall or cornered wall surface where platform edges are securely attached to the supporting wall which gives stability to the structure, added support to the platforms, and effectively restricts the movement of both so that frequent, carefree use by multiple cats is promoted. Exterior surface areas are covered with carpeting, sisal rope or some other claw receptive material that cats prefer. The invention satisfies the feline natural needs to climb, scratch, and perch in high places, and claims a number of unique additional advantages. The three simple components are not only lightweight and easy to assemble but are also interchangeable and reversible extending their useful life. In addition, components can also vary in shape and size allowing variability in the height and configuration of the structure. Construction is simple, therefore production and maintenance costs are low. And the invention can be installed in less than one square foot of space as only a post rest on the floor, the platforms attach to the structure at any height reducing use of valuable floor space.

### BRIEF DESCRIPTION OF THE DRAWINGS

FIG. 1 is a front perspective view of the preferred embodiment of the wall supported modular cat furniture structure fully assembled in a corner wall configuration.

FIG. 2 is an exploded front perspective view of the structure of FIG. 1 showing the individual modular components and their interconnecting surfaces.

FIG. 3 is a front view of a piece of plywood used to construct a platform component showing the relative location and size of the hole made therein.

FIG. 4 is a front view of a piece of plywood used to construct a platform component showing the angle cut made thereto in relation to the hole and the plywood itself.

FIG. 5 is a side view of the plywood used to construct a platform component showing the relative positioning of the coupling that is cemented therein.

FIG. 6 is a top view of the two pieces of carpet which are custom cut to fit the outside surfaces of a right-cut platform component.

FIG. 7 is a front perspective view of an assembly of connected components prior to installation or more specifically prior to attachment to the supporting walls.

FIG. 8 is an enlarged view of the hardware used to install the preferred embodiment of the invention or more specifically to attach the preferred embodiment to the supporting walls.

FIG. 9 is an enlarged view of a metal support piece that is properly positioned between two marks on the wall.

FIG. 10 is an enlarged fragmented view of the side edge of a platform component shows the proper positioning of an insulated staple that is hammered therein.

FIG. 11 is an enlarged edge view of the angled cut end of a platform component showing the proper positioning and application of the insulated staple and the hose clamp.

### DETAILED DESCRIPTION OF THE INVENTION

Further disclosure of the wall supported modular cat furniture structure represents a preferred mode of constructing and utilizing the invention and is presented in terms of the “preferred embodiment” of the invention. However, it is to be understood that the following description, including the referenced illustrations, are not intended to limit the scope of the invention, since many options and variations are possible which will be be apparent to those skilled in the art.

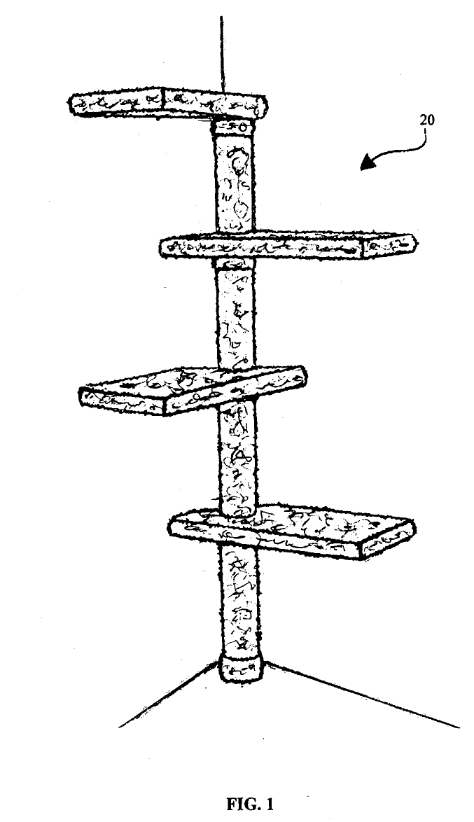

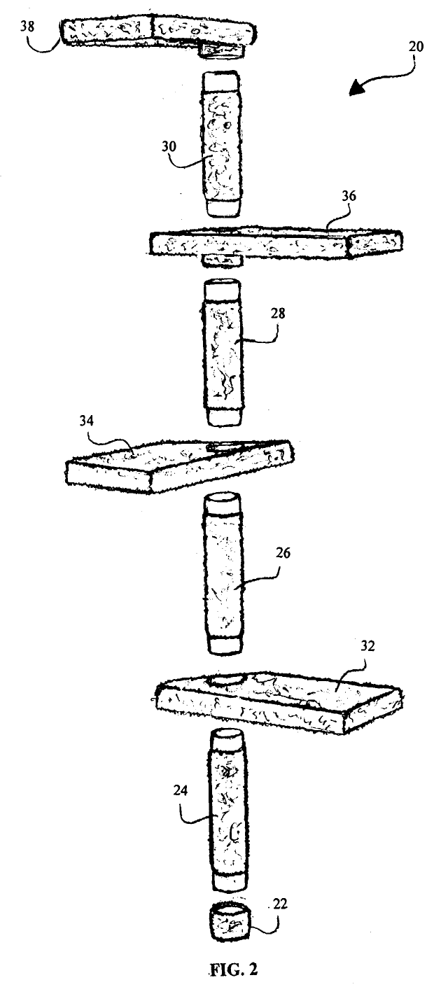

Referring now to the drawings, FIG. 1 is a front perspective view of the preferred embodiment of the wall supported modular cat furniture structure generally designated as 20. In FIG. 1, structure 20, in its intended use as a cat climber, scratcher, and perch, is fully assembled in a corner wall configuration. FIG. 2 is an exploded perspective view of structure 20 showing more fully the interconnecting portions of the individual components. Structure 20 is comprised of 3 types of modular components: base coupling, posts, and platforms. When connected together, as seen in FIG. 1, these components form a solid, sturdy, cat friendly structure that stands 62″ tall and weighs approximately 21 lbs. The inherent novelty and benefit of the invention lies in the design and construction of the individual components as well as in the assembly and installation of the structure. Both are detailed below.

Constructing the Modular Components of the Preferred Embodiment of the Invention.

The following describes one method of several possible methods for constructing the various components comprising the preferred embodiment of the invention. Referring to FIG. 2, a base coupling 22 is constructed from a standard two-inch PVC pipe coupling and a 2-¼″ by 9″ piece of carpet. Contact cement is used to securely affix the carpet to the outer surface of the coupling.

In FIG. 2, a post 24 is constructed from standard two-inch diameter PVC pipe cut to a length of 16″, and an 8″ by 13-⅜″ piece of carpet. Before affixing the carpet to post 24, use 36-grit sandpaper and then 80-grit sandpaper to sand around the end portions of post 24 until a tapered effect is created that allows coupling 22 to fit snuggly into yet be easily removable from either end of post 24. After tapering, use contact cement to attach the carpet piece to the middle portion of post 24, leaving 1-⅜″ at each end uncarpeted. In FIG. 2, a post 26, a post 28 and a post 30 are all constructed using the same method of construction described above for post 24 with the following exception. Post 28 and 30 are 14″ in length as opposed to the 16″ length of post 24 and 26. When constructing posts 28 and 30 the PVC pipe and the carpet piece should each be cut 2″ shorter to provide for this.

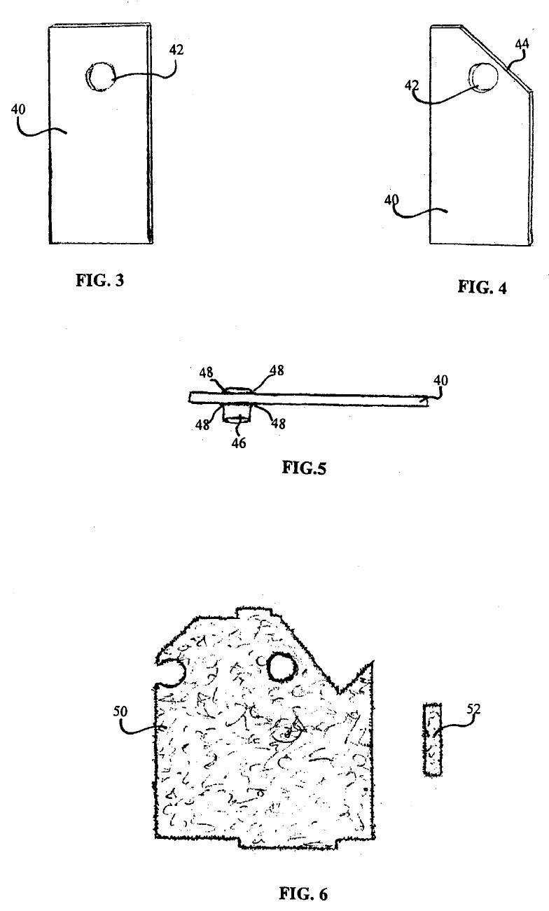

In FIG. 2 a right-cut platform 32 is constructed from plywood, carpet and a standard 2″ PVC coupling. Referring now to FIG. 3, right-cut platform 32 begins as a piece of plywood 40 that is ⅝″ thick, 10″ wide and 2441 long. Using an electric drill press and a 2¾″ Forsner drill bit, a 2¾″ hole 42 is drilled into what will be considered the top end of plywood 40 so that the center point of hole 42 is 5″ from the top and 5″ from each of the sides of plywood 40. In FIG. 4, a diagonal cut 44 is made along side hole 42 in plywood 40 which begins on the top edge at a point 7″ from the top right corner and ends down the right side edge of plywood 40 at a point 7″ from the same right top corner. FIG. 4 is a topside view of plywood 40 and since diagonal cut 44 is to the right of hole 42, plywood 40 is considered right-cut and becomes a right-cut platform once constructed. FIG. 5 is a side view of plywood 40 where a 2-inch PVC coupling 46 has been cemented into hole 42 using standard carpentry cement. Coupling 46 is cemented into hole 42 so that it is perpendicular to plywood 40 and so that ½″ of coupling 46 extends out the topside of plywood 40 and the remainder of coupling 46, approximately 2″, extends out the bottom side of plywood 40. A heavy bead of carpentry cement is applied and smoothed into and around area 48 to permanently cement coupling 46 into plywood 40. A second bead is later applied to area 48 to strengthen the connection and reinforce the surrounding plywood. In FIG. 6, a piece of carpet 50 and a piece of carpet 52 are cut from a pattern to tailor fit the exposed outer surfaces of plywood 40 and coupling 46. Carpet 50 is fitted around plywood 40 and is attached using a staple gun. The carpet segments that cover the ends of plywood 40 are creased and folded down, trimmed as needed, and then secured to the ends with contact cement followed by a number of staples for reinforcement. Carpet 52 is affixed to the exposed outer surface of coupling 46 using contact cement. In FIG. 2, a left-cut platform 34, a right-cut platform 36 and a right-cut platform 38 can all be constructed using the method of construction described above for right-cut platform 32 with the exception of the angle cut on left-cut platform 34 which is made on the opposite side.

Assembly and Installation of the Preferred Embodiment of the Invention

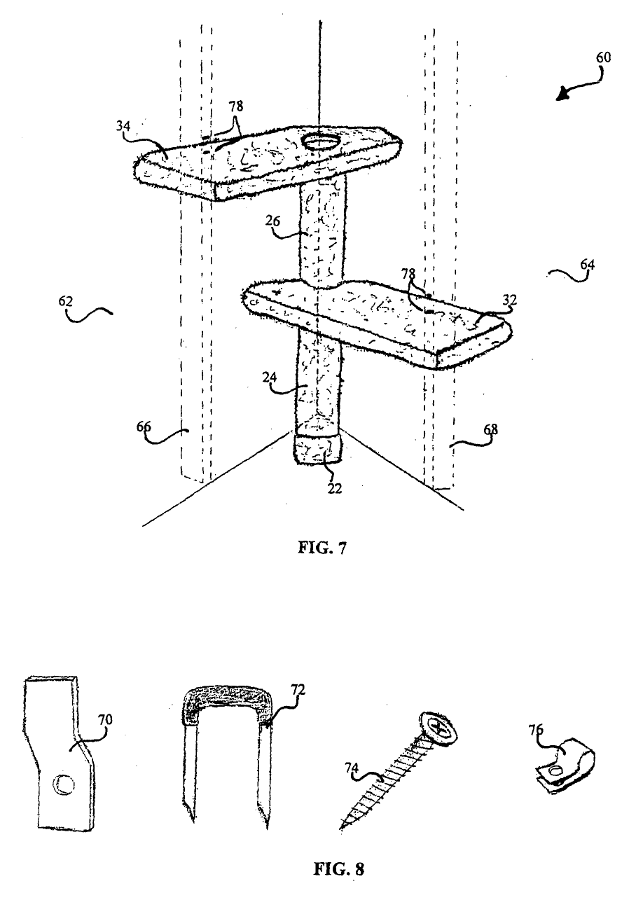

The following describes the assembly and installation of the preferred embodiment of the invention into a corner wall configuration. FIG. 7 shows a corner wall configuration 60 where a left-wall 62 meets a right-wall 64 at a 90-degree angle and where a left-wall stud 66 and a right-wall stud 68 are both located 16″ out from the corner. FIG. 8 depicts the different attachment hardware used to install the invention as described herein. These include a one inch long ½ inch wide metal support piece 70, a half-inch insulated staple 72, a#8×1¼″ wood screw 74, and a ⅜″ plastic hose clamp 76. The tools needed to complete the installation are a drill, a drill bit, a screwdriver, a hammer, a pencil, and scotch tape. (tools not shown).

Assembly begins by fitting one end of post 24 into one end of coupling 22 and then fitting the other end of post 24 into the bottom-side-coupling of right-cut platform 32. Post 26 is then press fitted into the top-side-coupling of right-cut platform 32 and the other end of post 26 is fitted with the bottom-side coupling of left-cut platform 34. As illustrated in FIG. 7, this structure is set into the corner with base coupling 22 on the floor adjustments are made so that post 24 and post 26 are parallel to left-wall 62 and right-wall 64 at a distance of 3¾ inches. In addition, right-cut platform 32 should fit squarely into the corner with its right edge flat against right-wall 64 and left-cut platform 34 should fits squarely into the corner with its left edge flat against left-wall 62.

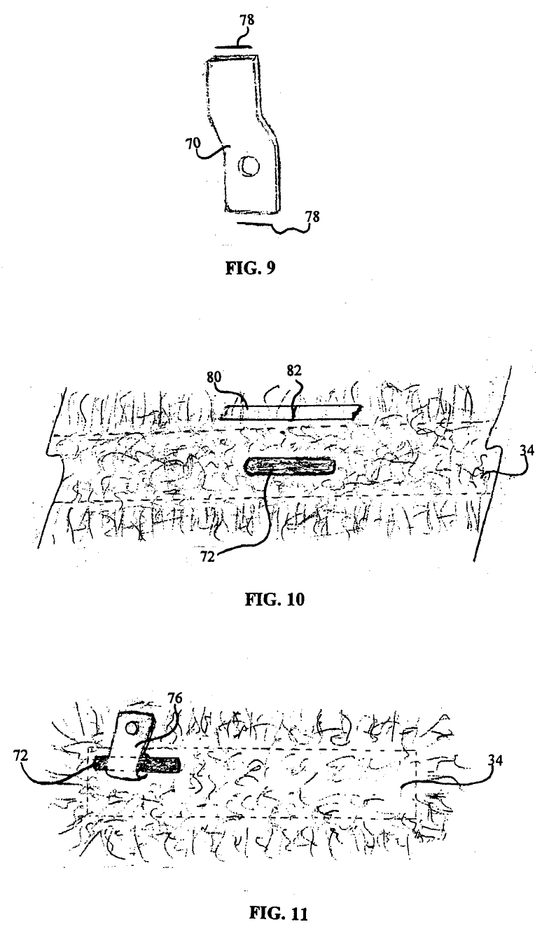

To attach the platforms to the wall surface first make sure that right-cut platform 32 and left-cut platform 34 are level or parallel to the floor, and that posts 24 and 26 are parallel to left-wall and right-wall 62 and 64 as illustrated in FIG. 7. Make the two small pencil marks 78 on right-wall 64, one just above and one just below the edge of platform 32 and both centered over right-wall stud 68. Repeat this procedure to get two small pencil marks 78 for left-cut platform 34 on left-wall 62. Remove the structure. Referring to FIG. 9, center one metal support piece 70 between the two marks 78 on right-wall 64 so that the end with the hole in it is down and flat or flush against the wall. Use the pencil to mark the wall where the hole of metal support piece 70 is and then drill a hole through the mark and into right-wall stud 68. Return metal support piece 70 to the wall and position as before. Drive one wood screw 44, through hole in metal support piece 70 and into right-wall stud 68 securely anchoring metal support piece 70 to right-wall stud 68. Repeat this procedure to anchor a second metal support piece 70 to left-wall stud 66. Return the structure to the corner and position as before. Place scotch tape 80 on top of right-cut platform 32, along the edge, directly above metal support pieces 70 and do the same to place a tape 80 on left-cut platform 34. For both platforms make a pencil mark on tape 80 to indicate the exact location of the respective metal support piece 70. Remove the structure and set right-cut platform 32 on the floor with the taped edge up. Referring to FIG. 10, center insulated staple 72 on the side edge of right-cut platform 32 and over mark 82 on tape 80 leaving a small gap between the top of staple 72 and the platform 32 so that metal support piece 70 can slide in between the two. Make adjustment and return structure to its position in the corner making sure to slide both insulated staples 72 over and down into both metal support pieces 70. Both platforms are now securely attached to the walls.

Referring to FIG. 2, insert post 28 into the top-side-coupling left-cut platform 34 and then press fit the bottom-side-coupling of right-cut platform 36 onto the top end of post 28. Attach right-cut platform 36 attached to right-wall 68 as described above for right-cut platform 32. When right-cut platform 36 is attached, insert one end of post 30 into the top-side-coupling of right-cut platform 36 and fit the other end of post 30 with the bottom-side-coupling of right-cut platform 38. Attach right-cut platform 38 to left-wall 62 as described above for left-cut platform 34. Because it is the top platform, right-cut platform 38 is additionally attached to the wall stud located in the corner. To do this remove right-cut platform 38 from the structure standing it on end, on the ground, with the coupling end up. Referring to FIG. 11, position one insulated staple 72 onto the top edge of right-cut platform 38 so that it is on the far right and closer to the top side of platform 38. Hammer staple 72 into platform 38, leaving a small gap as before and making sure that staple 72 is set solid into the plywood. Slide hose clamp 76 onto the insulated staple 72 as seen in FIG. 11, flipping it all the way around so that the flat side of clamp 76 is flat or flush against the wall and the ends are upward. Return right-cut platform 38 to its position in the structure, check that platform 38 is level and then drill through the holes in clamp 76 and into the corner wall stud. Drive one wood screw 74 through the holes in clamp 76 and into the corner wall stud.

What I claim as the invention is:

1. A wall supported modular cat furniture structure positionable adjacent to a supporting flat or corner wall surface, and comprising:
an upright support post extending vertically upward from the floor;
one or more horizontal platform components connected to said support post and extending outward therefrom; and
attaching means attaching said platform component to said wall surface.

2. The cat furniture structure of claim 1 wherein said support post is wrapped with sisal rope, carpet or other claw penetrable material cats prefer for scratching.

3. The cat furniture structure of claim 1 wherein said platform components are fitted with carpet or other claw penetrable material cats prefer.

4. The cat furniture structure of claim 1 wherein said support post comprises two or more post components linearly adjoined in an end to end relation extending vertically upward from the floor.

5. The cat furniture structure of claim 1 wherein said platforms components are adapted in size and shape to support cats, said platform components having top and bottom surfaces rectangular in shape with one platform corner adjacent said support post cut away.

6. The cat furniture structure of claim 1 wherein said attaching means comprise a metal support piece, a metal screw fastening said metal support piece to said wall surface, and an attachment staple which is hammered into a side edge of said platform component, said attachment staple is slid onto said metal support piece attaching said platform component to said wall surface.

7. A wall supported modular cat furniture structure positionable adjacent a supporting flat wall ar corner wall surface, and comprising:
a base coupling component having a first female end and a second female end that are same;
an upright support post comprising two or more post components linearly adjoined in an end to end configuration extending vertically upward from the floor;
two or more horizontal platforms components connected to said support post and extending outward therefrom, said platform components being adapted to support cats and having a top and a bottom surface rectangular in shape with one platform corner adjacent said support post cut away; and
attaching means attaching an edge of each said platform component to a supporting wall surface.

8. The cat furniture structure of claim 7 wherein each said post component has a first tapered male end and a second tapered male end that are same, said first and said second tapered male ends being easily and interchangeably press fitted into said first and said second female ends of said base coupling component.

9. The cat furniture structure of claim 7 wherein said platform components are pivotally connected to said support post between two adjacent said post components, said platform component comprising connecting means connecting adjacent said post components.

10. The cat furniture structure of claim 9 wherein said connecting means comprise an aperture centered at one end of said platform component, said aperture containing a platform coupling which is same in shape and form as said base coupling component, said platform coupling being permanently affixed within said aperture such that said platform coupling is perpendicular to the top and bottom surfaces of said platform component and such that a portion of said platform coupling extends from the top and bottom surfaces of said platform component.

11. The cat furniture structure of claim 10 wherein said attaching means comprise a metal support piece, a metal screw fastening said metal support piece to said wall surface, and an attachment staple which is hammered into a side edge of said platform component, said attachment staple is slid onto said metal support piece attaching said platform component to said wall surface.

12. The cat furniture structure of claim 10 wherein said first female end of said base coupling component is positioned facing downward on the floor and said second female end of said base coupling component faces vertically upward and receives said first tapered male end of a first post component, said second tapered male end of said first post component is subsequently press fitted with said first female end of said platform coupling of a first platform component, said first tapered male end of a second post component is press fitted into said second female end of said platform coupling of said first platform component, said second tapered male end of said second post component is subsequently press fitted with said first female end of said platform coupling of a second platform component, said attaching means attaching said side edges of said first and said second platform components to said wall surface.

13. The cat furniture structure of claim 12 wherein the outer surface said post components, with the exception of the tapered male ends, are wrapped with sisal rope, carpet or other claw penetrable material cats prefer for scratching.

14. The cat furniture structure of claim 12 wherein the outer surfaces of said platform components are fitted with carpet or other claw penetrable material cats prefer. 15.

15. The cat furniture structure of claim 12 further including one or more connecting couplings wherein each said connecting coupling is same in shape and form as said base coupling, said connecting coupling positionable between two said post components, wherein said tapered male ends of said post components are press fitted into two female ends of said connecting coupling linearly connecting said post components.
